(19) United States
(12) Patent Application Publication
(10) Pub. No.: US 2013/0093579 A1
(43) Pub. Date: Apr. 18, 2013

(54) DRIVER ASSISTANCE SYSTEM

(71) Applicant: Marc Arnon, Benningen Am Neckar (DE)

(72) Inventor: Marc Arnon, Benningen Am Neckar (DE)

(21) Appl. No.: 13/653,933

(22) Filed: Oct. 17, 2012

(30) Foreign Application Priority Data
Oct. 17, 2011 (DE) 10 2011 084 618.2

(51) Int. Cl. B60Q 1/00

(52) U.S. Cl. 340/425.5

(57) ABSTRACT

A driver assistance system includes an outside mirror device, which has a partially transmitting mirror and a display device for displaying at least one optical warning signal of the driver assistance system, the display device having an optical system situated behind the partially transmitting mirror and being equipped to make visible the optical warning signal in the form of a virtual image visible to the driver behind the partially transmitting mirror.

### CROSS REFERENCE TO RELATED APPLICATION

The present application claims priority to Application No. DE 10 2011 084 618.2, filed in the Federal Republic of Germany on Oct. 17, 2011, which is expressly incorporated herein in its entirety by reference thereto.

### FIELD OF INVENTION

The present invention relates to a driver assistance system having an outside mirror device which has a display device for displaying at least one optical warning signal of the driver assistance system.

### BACKGROUND INFORMATION

An example of such a driver-assistance system is a lane change assistant for motor vehicles. Such lane change assistants have a sensor system, for example, for locating vehicles on adjacent lanes in the back space of the host vehicle, and are supposed to save the driver from swinging out to an adjacent lane if an overtaking vehicle is approaching from behind, so that there would be a collision risk or at least an obstruction of the overtaking vehicle. In most cases a rear-space radar is used as sensor system in such lane-change assistants, i.e., a radar sensor which points to the rear or obliquely to the rear and is able to measure the distances, relative velocities and azimuth angles of the located vehicles. If a vehicle is located on the adjacent lane, and if it is determined, based on its distance and relative speed, that changing to the adjacent lane is not possible without endangering the following traffic, and if in addition, based on the traffic situation or based on actions of the driver such as the operation of the turn signal indicator, steering actions and the like, it is recognizable that the driver intends to change lanes, a warning sign is output to the driver via a driver interface. Especially useful is the output of an optical warning signal by a display device which is integrated into the respective outside mirror of the vehicle.

In such systems, a warning signal usually takes place optically by a display mounted in the glass or in the housing of the outside mirror. German Application No. DE 103 18 741 A1 describes a driver assistance system having a lane changing assistant, in which a light-emitting diode is situated on the outside mirror between the mirror surface and the outside of the vehicle, in the vicinity of the mirror mounting bracket. At a high danger level, the light-emitting diode is operated so that it emits a red blinking signal. According to another suggestion, the mirror surface includes a flat screen, so that the driver may be given particularly detailed information.

### SUMMARY

During a warning display in the glass of the outside mirror, to perceive the traffic participants behind and the warning signal, the driver has to focus his eyes on various low planes.

It is an object of the present invention to create a driver assistance system in which the optical warning signals are able to be perceived more simply.

This object is attained by a driver assistance system having an outside mirror device which has a partially transmitting mirror and a display device for displaying at least one optical warning signal of the driver assistance system, the display device having an optical system behind the partially transmitting mirror, which is equipped to make visible the optical warning signal in the form of a virtual image visible to the driver behind the partially transmitting mirror.

The representation of the virtual image of the warning signal is thus able to take place in a focal plane that lies behind the partially transmitting mirror and preferably, particularly behind the outside mirror device. Consequently, no focusing of the eyes of the viewer on the mirror surface is required for the optical perception of the warning signal. Because of that, viewing the warning signal and the mirror image of the rearward vehicle surroundings is made easier for the driver. In particular, the simultaneous perception of the warning signal and of a mirror image of a traffic participant may be simplified.

The display device preferably has an illuminated display device. This is preferably situated in a retention bracket of the outside mirror device. The light path may thereby be elongated.

The display device preferably has an illuminated display device, and the optical system of the display device is equipped to make visible the optical warning signal in the form of the virtual image, the virtual image being enlarged compared to a representation on an illuminated display device. A greater image distance or apparent distance of the virtual image may thereby be achieved.

The optical system of the display device preferably has a mirror. A mirror makes possible rerouting the light of an illuminated display device, and is thus able to lengthen the light path. It is particularly preferred if this mirror is a concave mirror. Thereby, in a simple manner, a representation of the virtual image of the warning signal may take place in a distant focal plane. In one specific embodiment, the display device has an illuminated display device and the optical system situated behind the partially transmitting mirror in the form of a concave mirror, the concave mirror being designed to make visible the optical warning signal in the form of a virtual image visible to the driver behind the partially transmitting mirror of an optical warning signal displayed by the illuminated display device. Because of an illuminated display device situated in the retention bracket of the outside mirror device, the distance from the concave mirror may be increased.

The display device is preferably hidden in a housing of the outside mirror device. The outside mirror device may include a retention bracket, for example, and the display device, particularly an illuminated display device of the display device, may be hidden at least partially in the retention bracket. The display device hidden in the housing may be perceptible, for example, exclusively through the partially transmitting mirror in the form of the virtual image generated by the optical system that is also hidden in the housing. The display device is thus able to be integrated, optically inconspicuously, into the outside mirror device.

The illuminated display device preferably has self-luminous display elements, for instance, self-luminous OLED display elements. An especially good contrast may therefore be achieved between a luminous, displayed warning signal and non-luminous areas of the illuminated display device. This is particularly advantageous, since it makes possible that only a luminous warning signal or warning symbol is perceived as a virtual image, which is superposed on the mirror image of the outside mirror.

The illuminated display device may also be a laser display. This makes possible a particularly good contrast and a high luminous density. Such a laser display is known for head-up displays, for example. It has a laser-optical system, for example, which is designed to write or project a warning signal onto a reflecting surface of the laser display.

The driver assistance system includes a driver position detection device, for example, for detecting a position of the driver, particularly of a head position of the driver, the display device being designed to display warning signals at different positions, and the driver-assistance system being designed to actuate the display device to output a warning signal at a position which is based on a detected position of the driver. Thereby, the position at which the virtual image may be seen is able to be adjusted to the position of the driver.

According to one refinement of the present invention, the driver assistance system has a monitoring system, for instance, a sensor system for locating objects in the lateral or rearward-facing surroundings of the host vehicle, and the display device is designed for displaying warning signals to different positions, and the driver assistance system is designed to actuate the display device to output a warning signal at a position that is a function of the position of a located object. In other words, the driver assistance system is designed to determine a position for displaying a warning system as a function of a position of a located object. Thereby the position of the displayed warning signal may, for instance, give information on the position of the relevant object in the lateral rear-view mirror. Consequently, warnings of certain objects or obstacles are able to be issued in a more targeted manner. In connection with the driver-protection detection device, the position at which the virtual image is able to be seen may be matched better with the position of the object.

Exemplary embodiments of the present invention are explained in greater detail in the following description with reference to the accompanying drawings.

### BRIEF DESCRIPTION OF THE DRAWINGS

FIG. 1 shows a block diagram of a driver assistance system according to the present invention.

FIG. 2 shows a schematic sketch of the outside mirror device and of a virtual image of an optical warning signal.

FIG. 3 shows a schematic sketch of a visible object and a corresponding warning symbol displayed on the outside mirror device.

### DETAILED DESCRIPTION

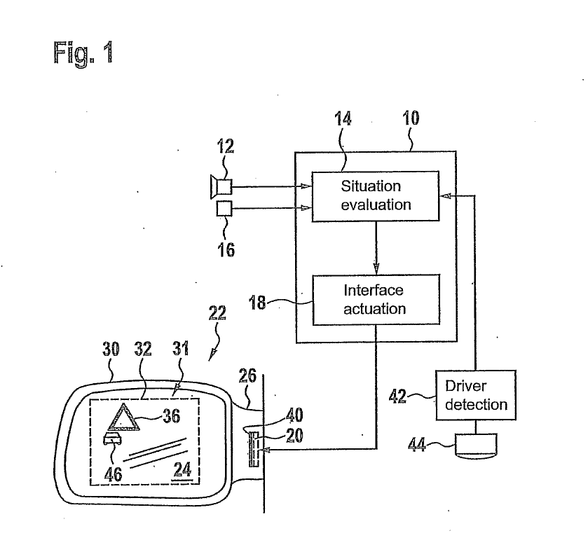

The driver assistance system shown in FIG. 1, in the form of a lane change assistant 10 (LCA), includes a monitoring system 12 in the form of a sensor system, for instance, a rear space radar for locating vehicles and other objects in the lateral or rear surroundings of the host vehicle. Lane change assistant 10 includes a situation evaluation module 14, which receives signals from monitoring system 12 and from a device 16 for detecting a lane change desire of the driver, and is connected to an interface actuation module 18 for actuating an illuminated display device 20. Illuminated display device 20 forms a warning device for outputting a warning notice to the driver, as will be explained below. Situation evaluation module 14 and interface actuation module 1-8 are formed by an electronic data processing system having suitable software, for example.

The situation evaluation module is developed in a method known per se to detect and evaluate a driving situation with the aid of signals of monitoring system 12, and to actuate interface actuation module 18 to output a warning notice to the driver when the situation evaluation shows that swinging out could lead to a collision, and a lane change desire of the driver is detected. This function of a lane changing assistant as well as devices for detecting such a lane change intention of the driver are known as such and are not described further in this context.

The driver assistance system according to the present invention includes an outside mirror device 22, shown schematically in FIGS. 1 to 3, having a mirror 24 and a retention bracket 26, by which the outside mirror device is fastened to a motor vehicle door 28, or to another region of the vehicle body.

Mirror 24 is a partially transmitting mirror. Behind mirror 24, and hidden in a housing 30 of outside mirror device 22, there is an optical system 31 in the form of a concave mirror 32. Illuminated display device 20 is situated in retention bracket 26, and is also hidden in housing 30.

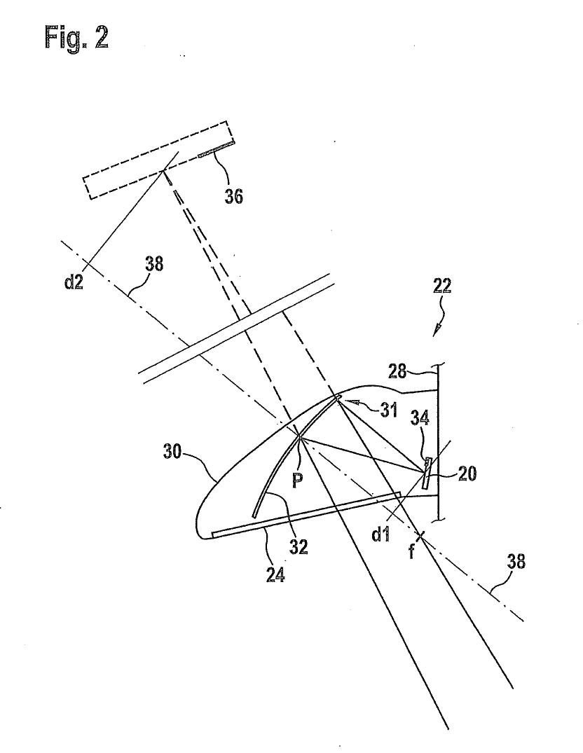

Concave mirror 32 is situated relative to illuminated display device 20 in such a way that a virtual image of illuminated display device 20 is created in a plane behind concave mirror 32. When an optical warning signal 34 is displayed on the self-illuminating illuminated display device, as is shown schematically in FIG. 2, a virtual image 36 of the warning signal is generated, which is visible to the driver behind partially transmitting mirror 24, in particular in a focal plane lying behind concave mirror 32 and (apparently) behind the outside mirror device. Illuminated display device 20 and optical system 31 thus form a display device for displaying warning signal 34.

Distance d1 of illuminated display device 20 from concave mirror 32 and the apparent distance d2 of the virtual image behind concave mirror 32 are linked approximately by representational equation

1/d1+1/d2=1/f

to focal length f of the concave mirror, d1 being positive and designating a distance on the front side of the concave mirror, and d2 being negative and designating the distance of the virtual image behind the concave mirror. Illuminated display device 20 is situated within positive focal length f of concave mirror 32. Concave mirror 32 has a concave mirror surface having a radius of curvature which amounts to approximately twice focal length f. The mirror surface is preferably curved to be spherical.

In a sectional representation, FIG. 2 shows the imaging of a point in the middle of illuminated display device 20 onto the virtual image. Distance d1 and focal length f are shown on a main axis 38 of concave mirror 32 going through the focal point. Main axis 38 radially hits concave mirror 32 at point P. A ray originating from the center of illuminated display device 20, which hits point P, is reflected, the angle of incidence being equal to the angle of reflection. A ray originating from the center of illuminated display device 20 parallel to main axis 38 is reflected so that it runs though the focal point. The location of the virtual image is the apparent origin of the reflected rays. The virtual image is equal-sided with respect to main axis 38. It is enlarged. Magnification factor m corresponds to the quotient of image d2 of the virtual image and object distance d1, i.e. m=d2/d1.

The arrangement of concave mirror 32 and illuminated display device 20 is selected so that virtual images 36 of optical warning signals 34 displayed on illuminated display device 20 are visible to the driver, and overlay the mirror image of the traffic surroundings. For instance, the distance of virtual images 36 from the partially transmitting mirror is at least 10 cm, preferably at least 50 cm, particularly preferred 1 m. The distance of virtual images 36 from the eye of the driver is preferably at least 1.5 m, particularly preferred at least 2 m. A distance in the range of 1.5 m to 2 m generally does not yet require any close accommodation of the eye, so that virtual image 36 is visible and recognizable at distance accommodation of the driver's eye, and as a result, the perception of the virtual image is facilitated greatly.

Illuminated display device 20, for example, has a plurality of self-luminous display elements 40, perhaps a display matrix of display elements 40, such as a flat screen. Display elements 40 are preferably OLED display elements (organic light-emitting diodes). The illuminated display device thus enables the display of warning symbols. FIG. 1 shows schematically a virtual image 36 of a warning signal in the form of warning symbols.

A driver position detection device 42 is optionally provided with a sensor 44 in the form of an inside space camera, in order to record the position of the head of the driver.

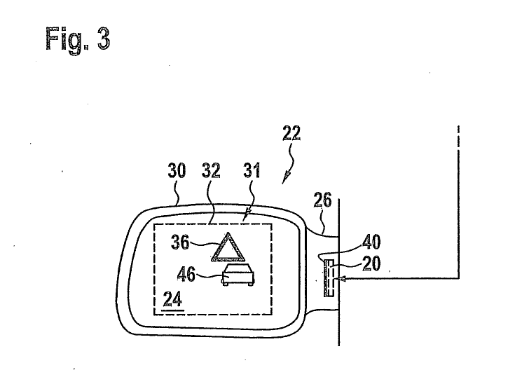

As explained above, the situation evaluation module carries out a situation recognition and evaluation as a function of the signals of monitoring system 12, and, as a function of the result of the situation evaluation, actuates illuminated display device 20 to generate optical warning signal 34. In doing this, the situation evaluation module determines a position for displaying warning signal 34 as a function of the position of a located object 46 and of the detected head position of the driver. Thus, for example, the position of virtual image 36 of the warning symbol is able to give information on the position of the respective relevant object 46 in the mirror image of mirror 24 that is visible to the driver. For example, the situation evaluation module is able to determine the position for displaying warning signal 34, so as to adjust the position of virtual image 36 of the warning symbol to the position of the respective relevant object 46 in the mirror image, visible to the driver, of mirror 24. Thus, for example, in the case of a larger transverse offset of a located object relative to the host vehicle and/or a greater distance of the located object in the longitudinal direction behind the vehicle, which corresponds to a position further out in the mirror image, a warning symbol may be displayed further out, as shown schematically in FIG. 1. By contrast, an object having a smaller transverse offset and/or a lower distance will be visible farther inwards on the outside mirror, as sketched in FIG. 3, and a corresponding warning symbol is able to be displayed farther inwards, that is, in the case of a left outside mirror, farther to the right.

The situation evaluation module may be equipped to determine the position of the object in a mirror image, that is visible to the driver, of mirror 24, based on the position of a located object and based on the imaging properties of outside mirror 24. The position for displaying warning signal 34 may then be adjusted to the determined position of the object in the mirror image that is visible to the driver.

Whereas, in the example described, optical system 31 of the display device is formed only by concave mirror 32, the virtual image of warning signal 34 may also be generated in a corresponding manner by an optical system having a planar mirror and a collective lens. If illuminated display device 20 is situated within the focal length of the collective lens, an enlarged virtual image is generated, whose focal length is greater than the distance of illuminated display device 20 from the collective lens.

While, in the example described, optical system 31 makes visible a virtual image of a representation of illuminated display device 20, other forms of display devices are also conceivable. Thus, for example, the optical system may include at least one hologram, and the display device may include at least one light source, in order to make visible the hologram as a virtual image behind the partially transmitting mirror.

Alternatively or in addition to a sensor system for monitoring a lateral and/or rearward surroundings of the host vehicle, monitoring system 12 may also have a vehicle communications system for receiving location information on vehicles in the lateral and/or rearward surroundings of the host vehicle, in particular a vehicle communications system for communicating with a communications system outside the host vehicle. Such systems are also called Car2Car communications systems. Furthermore, a monitoring system 12 may be equipped to receive location information with respect to the host vehicle from a GPS system. Monitoring system 12 may, for instance, include a GPS system. Consequently, vehicles may also be located in the surroundings via the vehicle communications system

What is claimed is:

1. A driver assistance system of a host vehicle, comprising:
an outside mirror device having a partially transmitting mirror and a display device for displaying at least one optical warning signal of the driver assistance system,
wherein the display device has an optical system situated behind the partially transmitting mirror, the optical system being equipped to make visible the optical warning signal in a form of a virtual image visible to a driver behind the partially transmitting mirror.

2. The driver assistance system according to claim 1, further comprising:
a monitoring system for monitoring at least one of lateral and rearward surroundings of the host vehicle,
wherein the driver assistance system is equipped to actuate the display device to generate the optical warning signal, as a function of a situation evaluation that is a function of signals of the monitoring system.

3. The driver assistance system according to claim 1, wherein the system forms a lane change assistant.

4. The driver assistance system according to claim 1, wherein the display device has an illuminated display device and the optical system of the display device is equipped to make the optical warning signal visible in the form of the virtual image that is visible to the driver behind the partially transmitting mirror and is magnified with respect to a representation on the illuminated display device.

5. The driver assistance system according to claim 1, wherein the optical system of the display device has a mirror.

6. The driver assistance system according to claim 5, wherein the mirror of the optical system is a concave mirror.

7. The driver assistance system according to claim 1, wherein the display device has an illuminated display device, which is situated in a retention bracket of the outside mirror device.

8. The driver assistance system according to claim 1, wherein the display device is hidden in a housing of the outside mirror device.

9. The driver assistance system according to claim 1, wherein the display device has an illuminated display device having self-illuminating display elements.

10. The driver assistance system according to claim wherein the display device has a display matrix.

11. The driver assistance system according to claim 1, wherein the driver assistance system is equipped to output the warning signal in a form of a warning symbol displayed by the display device.

12. The driver assistance system according to claim 1, further comprising:
a monitoring system for locating objects in at least one of lateral and rearward surroundings of the host vehicle,
wherein the display device is equipped for displaying warning signals at different positions, and
wherein the driver-assistance system is equipped to actuate the display device to output the warning signal at a position which is a function of a position of a located object.
